(19) United States
(12) Patent Application Publication
(10) Pub. No.: US 2013/0111545 A1
(43) Pub. Date: May 2, 2013

(54) Privacy Management for Subscriber Data

(71) Applicants: Alok Sharma, Lisle, IL (US); Yigang Cai, Naperville, IL (US)

(72) Inventors: Alok Sharma, Lisle, IL (US); Yigang Cai, Naperville, IL (US)

(73) Assignee: Alcatel-Lucent USA Inc., Murray Hill, NJ (US)

(21) Appl. No.: 13/287,264

(22) Filed: Nov. 2, 2011

(51) Int. Cl. G06F 21/24

(52) U.S. Cl. 726/1

(57) ABSTRACT

Methods, systems, and apparatuses for privacy management comprise maintaining a database of subscriber data and subscriber consent rules associated with the subscriber data, receiving a consent request for selected subscriber data, determining a consent rule associated with the selected subscriber data, wherein the consent rule is determined based on user-type criteria, and transmitting a parameter associated with the selected subscriber data if the consent rule is satisfied.

### TECHNICAL FIELD

The present disclosure relates to privacy management for subscriber data maintained by a telecommunications service provider.

### BACKGROUND

Telecommunications service providers are currently looking for solutions that enable the monetization of their network assets beyond traditional models such as long-distance and toll-free calling services. For example, service providers can turn the vast amounts of data they have about their subscribers into valuable “contextual” information for third-parties. However, this subscriber data is often not readily accessible to third-parties, and is not typically exposed in a manner that is both efficient and secure. Oftentimes, privacy management requires multi-step processes, including the manual interception of data one wishes to secure. Privacy management is also typically geared towards protecting data originating from various enterprise applications, rather than from service providers. As such, there is often no correlation between different methods of privacy management, and no audit-trail capability for data exchanged between service providers and enterprises.

### SUMMARY

The present disclosure relates to privacy management of subscriber data. In one embodiment, a database of subscriber data and subscriber consent rules associated with the subscriber data is maintained. A consent request for selected subscriber data is received. A consent rule associated with the selected subscriber data is determined, wherein the consent rule is determined based on user-type criteria. A parameter associated with the selected subscriber data is transmitted if the consent rule is satisfied. The consent request may be received from one of an enterprise application, Web-based application or mobile application.

In accordance with an embodiment, the user-type criteria may be based on an identity of a requesting entity or a target entity, or on a location of a requesting entity or a target entity.

In accordance with an embodiment, the consent rule may be based on at least one of application, group, temporal or frequency-based criteria and may be generally enforceable for consent requests or enforceable for a particular operation of a consent request. The consent rule may also be satisfied by a subscriber opt-in response.

Some embodiments of any of the above methods, apparatuses and computer-readable instructions further comprise determining a plurality of consent rules associated with the selected subscriber data, and transmitting the selected subscriber data if each of the plurality of consent rules is satisfied.

Some embodiments of any of the above methods, apparatuses and computer-readable instructions further comprise determining a hierarchy level associated with the consent request. The hierarchy level may be based on an identity of a requesting entity or a target entity. Subscriber management access for a consent rule may be based on the hierarchy level, and determining an access level for the selected subscriber data may be based on the hierarchy level.

These and other advantages will be apparent to those of ordinary skill in the art by reference to the following detailed description and the accompanying drawings.

### BRIEF DESCRIPTION OF THE DRAWINGS

FIG. 1 illustrates a function overview of a privacy management system according to an embodiment;

FIG. 2 illustrates a functional diagram of a privacy manager according to an embodiment;

FIG. 3 illustrates a layered privacy consent evaluation performed by the privacy manager according to an embodiment;

FIG. 4 illustrates a conflict resolution diagram for privacy rules according to an embodiment;

FIG. 5 illustrates a high-level consent request flowchart according to an embodiment;

FIG. 6A illustrates a consent request flowchart implemented by the privacy manager according to an embodiment;

FIG. 6B is a table illustrating the status of each parameter of the consent request flowchart of FIG. 6A;

FIG. 7A illustrates a consent request with callback flowchart implemented by the privacy manager according to an embodiment;

FIG. 7B is a table illustrating the status of each parameter of the consent request with callback flowchart of FIG. 7A;

FIG. 8A illustrates a cancel consent request flowchart implemented by the privacy manager according to an embodiment;

FIG. 8B is a table illustrating the status of each parameter of the cancel consent request flowchart of FIG. 8A; and

FIG. 9 is a high-level block diagram of an exemplary computer that may be used for implementing a subscriber context suite.

### DETAILED DESCRIPTION

In the various embodiments, a privacy manager allows telecommunications service providers to securely expose their subscriber data to third-parties. The privacy manager provides a service provider with a framework for managing and applying a variety of privacy policies based on criteria such as the application being used, the identity of the requesting entity (e.g., a subscriber using an application, the application itself, etc.) and the relationships the requesting entity has with other users, enterprises and applications.

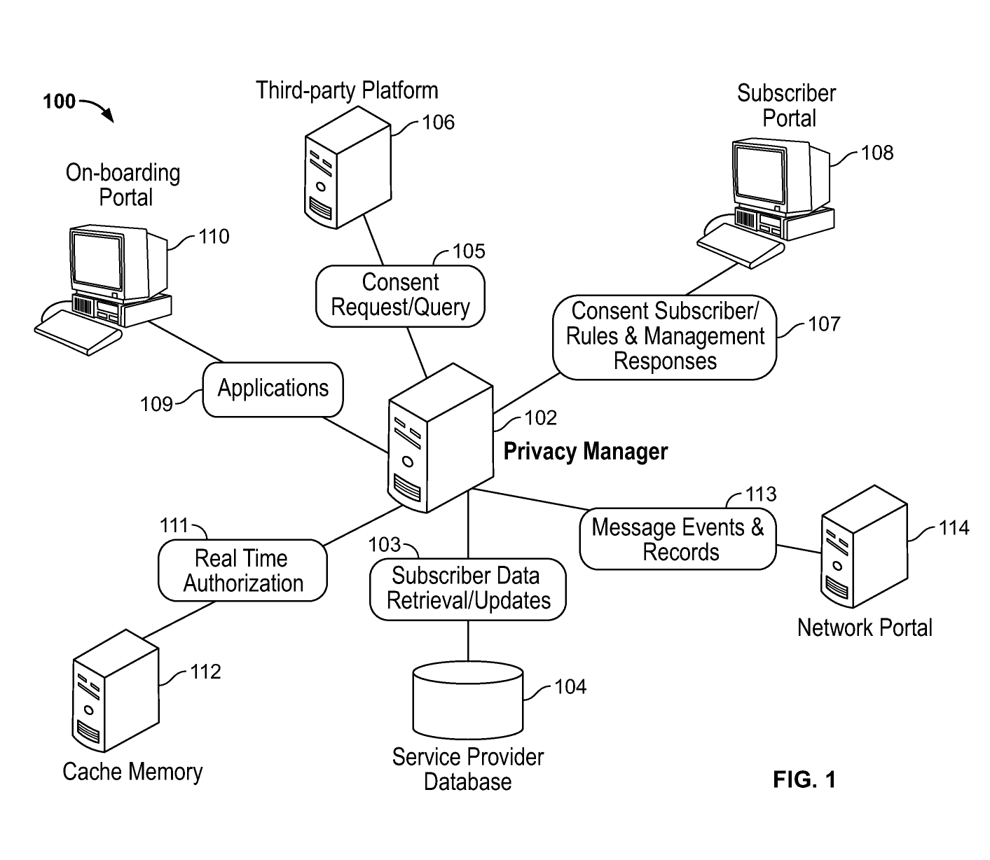

FIG. 1 illustrates a function overview of a privacy management system according to an embodiment. The system 100 includes a privacy manager 102 configured to retrieve and update subscriber data 103 stored at a service provider database 104 to provide privacy consent, privacy consent management and privacy event notification functions. For example, the privacy manager 102 may be implemented by a processor communicatively coupled to the service provider database 104, wherein the service provider database 104 is a digital data storage. When the privacy manager 102 receives a consent request/query 105 from a third-party platform 106 (e.g., an enterprise, mobile or Web-based application) to retrieve subscriber data 103, the privacy manager 102 may retrieve the requested subscriber data 103 from the service provider database 104 for exposure to the third-party, subject to subscriber consent rules and consent management responses 107 (e.g., a subscriber opt-in response). The subscriber consent rules and consent management responses 107 may be received at the privacy manager 102 from a subscriber (i.e., user) via a subscriber portal 108, such as a user equipment (UE) device or other input terminal. As explained in further detail below, the privacy manager 102 may then execute various applications 109, such as those provisioned via an on-boarding (application/developer management) portal 110, to apply the subscriber consent rules and consent management responses 107 to the consent request/query 105. In some instances, the privacy manager 102 may store received subscriber consent rules and management responses 107, such as those related to persistent consent requests 105, for real-time authorization 111 via a cache memory 112. The privacy manager 102 may also record consent request/query message events other records 113 (e.g., metrics or audit-trail records) at a network management system that is accessible via a network portal 114.

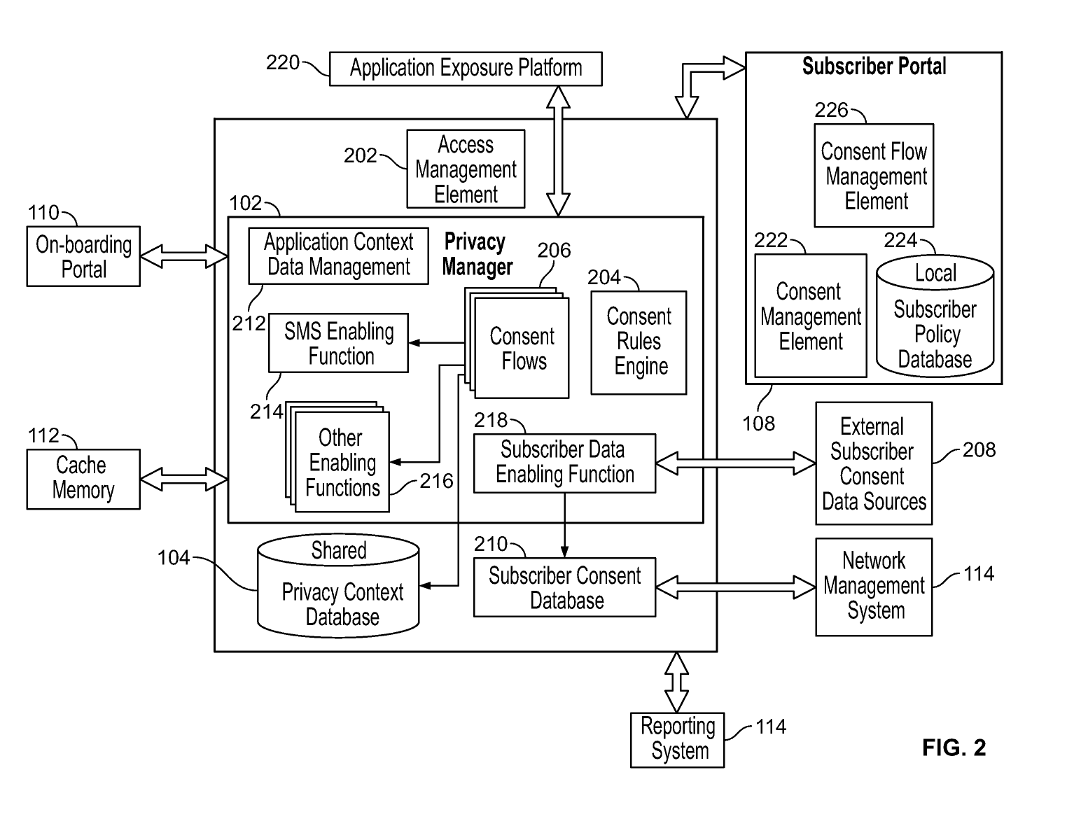

FIG. 2 illustrates a functional diagram of a privacy manager according to an embodiment. In one embodiment, the privacy manager 102 includes an access management element 202, which controls access to the privacy manager 102 among various interfaces (e.g., application programming interfaces or APIs), and a consent rules engine 204 which provides the processing framework for executing, generating, receiving and managing privacy consent call-flows 206 (i.e., communications; also referred to herein as “consent flows”) used for obtaining and controlling access to subscriber data, such as the subscriber data typically maintained by a telecommunications service provider. The processing framework for the privacy manager 102 may therefore be understood through the functions that may be performed by the privacy manager 102 in cooperation with one or more APIs and a digital data storage during the course of a consent flow.

The privacy manager 102 stores subscriber consent data received from one or more subscriber portals 108 or other external subscriber context data sources 208 at the subscriber consent database 210 (or cache memory 112) for use during consent flows. Specifically, the consent rules engine 204 accesses the subscriber consent database 210 to determine the rules for allowing a requesting entity to access selected subscriber data.

The shared privacy context database 104, which may comprise the service provider database shown in FIG. 1, is configured for persistent storage of application context data for consent flows, consent rule context data related to consent flow execution, and consent flow measurements. In one embodiment, An application context data management element 212 collects application context data related to consent requests via interface links to appropriate on-boarding portals 110 and stores the context data in the shared privacy context database 104 for use in determining and enforcing privacy rules and policies, and for creating a centralized data repository that may be used to support persistent data storage across a general application exposure platform 220. It will be noted by those skilled in the art that while FIG. 2 shows the privacy manager 102 implemented as a stand-alone platform, in other embodiments one or more of the functions of the privacy manager 102 may be integrated into or implemented within a general application exposure platform 220.

Consent flows 206 may be managed individually by the privacy manager 102 or as bundles depending on deployment and real-time management requirements. For example, certain consent flows 206 may include common processes that may be advantageous for bundling. These processes may be exposed using APIs and managed via the access management element 202 to bundle tasks and interface with appropriate components to manage end-user interactions. For example, the access management element 202 may control the actual deployment of flows and the privacy manager's 102 connections to other services and APIs.

In general, the privacy manager 102 may be configured to support external and internal interfaces using a variety of known protocols. For example, the privacy manager 102 may interface with APIs to perform any of the functions described herein including real-time consent requests, application provisioning, subscriber consent management, subscriber data retrieval, and SMS notifications. The access management element 202 may provide authentication and authorization control for the interfaces that are supported by the privacy manager 102, including the consent flow interfaces. In one embodiment, the access management element 202 provides security and access control for the APIs that are exposed by consent flows. For example, the privacy manager 102 may determine, based on the API (location) and the requestor (a social network application), what level of information (e.g., location data) can be retrieved for the target subscriber. For example, a social network application may only be authorized for a low level of accuracy data (e.g., zip code level), while an emergency responder application may receive a high level of accuracy data (e.g., an address or global positioning location). In one embodiment, various rules and permissions may be used to determine whether a given user has permission to access or configure the access management element 202.

The privacy manager 102 further includes various enabling functions, operable during consent flows, for SMS 214 (allowing flows that send and receive SMS messages), subscriber data (allowing flows that query a subscriber's privacy consent data), location (allowing flows that retrieve the location of a subscriber), application context data (allowing flows that access the context data of an associated application), and other functions 216. For example, the consent rules engine 204 may activate an SMS enabling function 214 for transmitting opt-in request or confirmation messages to a subscriber (or other entity), such as during a real-time consent flow. For example, an SMS message may be transmitted to a subscriber confirming that an opt-in request has been successfully processed, or a subscription notification message may be transmitted to inform a subscriber that a new application is attempting to access their data. In another example, the consent rules engine 204 may activate a subscriber data enabling function 218 for a subscriber authorization lookup flow to look up appropriate subscriber consent data at the subscriber consent database 210 or at another external source 208.

In one embodiment, the subscriber portal 108 includes a subscriber level consent management element 222 that allows subscribers and/or administrators to manage subscriber consent data. For example, the subscriber portal consent management element 222 may be configured for adding, updating, viewing and removing subscriber consent data. The management element 222 may also store the subscriber consent data in a local subscriber policy database 224. In one embodiment, the database 224 may support different levels of subscriber management and consent data control. For example, a parent subscriber may have control over a child subscriber's consent data. Other management levels may be configured for service providers, enterprises or other entities. Moreover, these levels may be used, not just for the management of subscriber consent data, but also for consent policies applied in APIs.

In addition, a consent flow management element 226 may allow service providers (or trusted service provider partners) to manage consent flows 206. In one embodiment, the consent flow management element 226 governs and controls the lifecycle of consent flows, loading and unloading of consent flows, activating and deactivating of consent flows, viewing the status of consent flows, provisioning flows, uploading new flows, and de-installing flows.

Consent rules may be based on any combination of application, requestor, group-based, date/time-based and frequency-based criteria. Consent rules may also be adjustable based on location information (e.g., resolution and precision), such as information provided by location-based applications received by the privacy manager 102 during consent flows.

Flow policies are rules that allow for the control and optimization of a consent flow 206. In one embodiment, these policies may include: subscriber consent (e.g., consent lists), application access, SLA and quota (the number of times the application or subscriber is trying to access a given subscriber's information), the date and time of an access attempt by a particular application or subscriber, and the location of the application or subscriber trying to access the subscriber information.

Policy/rule enforcement refers to the runtime evaluation and processing of privacy rules/policies performed by the consent rules engine 204 during the execution of consent flows. In one embodiment, policy enforcement is decoupled from the actual rule/policy definition and deployment process to reduce the complexities of dealing with changing policies. The rules engine 204 evaluates and enforces rules/policies associated with the execution of consent flows in relation to the current conditions (e.g., the application executing the consent flow, the subscriber executing the application, the resources used for executing the request, etc.). For example, the subscriber portal 108 may push consent rules to the rules engine 204, while the subscriber portal 108 configures/manages the policy templates for flows and application identity association.

The various rule types can be configured and then enforced at runtime. In one embodiment, the rule types can be applied generally for a consent flow or for selected (or a single) operation within a consent flow. For example, custom consent flow rules can be used to allow developers of consent flows to use rules within their logic, allowing them to dynamically change the behavior of the flows without having to change the logic.

In one embodiment, the consent rules engine 204 assigns (e.g., through an identifier) and applies privacy policies and rules according to user-type criteria, such as an account or application level hierarchy. For example, account hierarchy levels may include service provider (i.e., carrier), enterprise (e.g., a corporate entity with multiple accounts), account-holder (e.g., a parent with multiple accounts in a family) and individual subscriber levels. Rules that apply to one hierarchy level (e.g., a service provider level) may apply differently, or not at all, to another hierarchy level. For example, service provider level policies may be configured to override all other policies, account holder policies may override subscriber level policies, third-party policies may override aggregator policies, etc. Further, a higher account-level (e.g., a service provider level) may have exposure or management access control over a lower account level (e.g., an individual subscriber level). Similarly, application levels may comprise a hierarchy of applications, third-parties and aggregators.

In one embodiment, the rules may be evaluated at two sets of levels. At the requestor level, the rules are evaluated based on the entity that is requesting the information on the target. For example, a requestor-level hierarchy may include application, requestor (subscriber) and group (e.g., an enterprise or aggregator which the application or requestor is associated with) levels. At the target level, the rules are evaluated based on the subscriber whose information is being requested. For example, the target level may include service provider, enterprise and account levels.

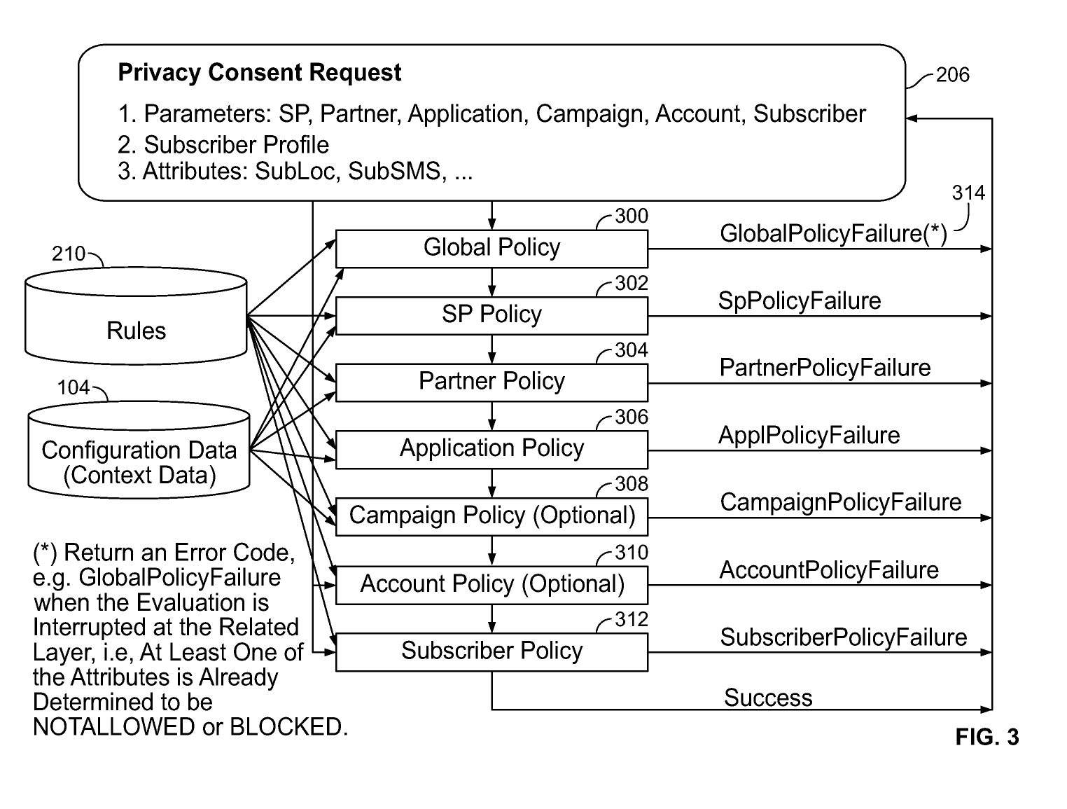

FIG. 3 illustrates a layered privacy consent evaluation performed by the privacy manager according to an embodiment. When a consent request/query 206 is received, the rules engine 204 may apply stored consent rules 210 and context (configuration) data 104 to the consent request in a layer format. For example, the layers of an evaluation may include global policy 300 (e.g., rules/context data that apply to all consent requests), service provider policy 302, partner policy 304 (rules/context data applied by a trusted partner such as a secure enterprise application), application policy 306 (applicable for a particular application), campaign policy 308 (applicable for select time periods or subscribers), account policy 310 (applicable for particular accounts) and subscriber policy 312 (based on subscriber data and opt-ins). In one embodiment, the attribute values ALLOWED, NOTALLOWED, BLOCKED, REQUIRED and GETCONSENT may define conflict resolution states for consent rules. For example, the rules engine 204 may return an error code, e.g., “GlobalPolicyFailure” 314, when an evaluation is interrupted at the related layer, such as if one of the attributes is determined to be NOT ALLOWED or BLOCKED.

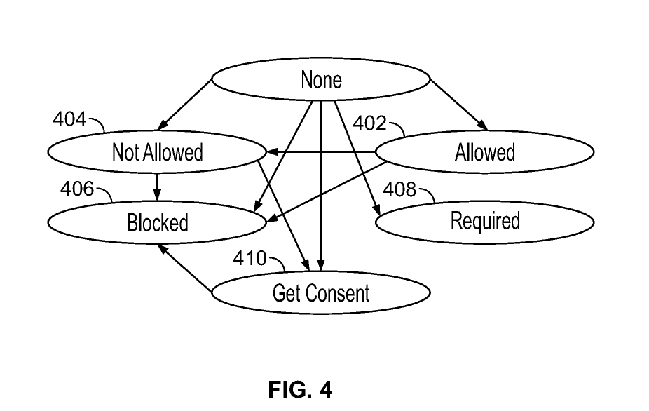

FIG. 4 illustrates a conflict resolution diagram for layered privacy rules according to an embodiment. As mentioned above, the attribute values ALLOWED 402, NOTALLOWED 404, BLOCKED 406, REQUIRED 408 and GETCONSENT 410 may define conflict resolution states for consent rules. In one embodiment, a next layer rule may be evaluated only if no attribute has a value of NOTALLOWED 404 or BLOCKED 406. An attribute value of ALLOWED 402 may be changed to NOT ALLOWED 404, BLOCKED 406 or GETCONSENT 410 by a next layer privacy rule. Each layer may have several rules, and it may be possible in various instances that values assigned by layer rules will not be consistent (e.g., the first rule set to the value ALLOWED 402, the second—NOTALLOWED 404 and the third—ALLOWED 402 again). Therefore, the conflicts may be resolved by defining allowed value transitions, or value priorities. For example, the new value for the transition ALLOWED 402 to NOTALLOWED 404 may be defined as NOTALLOWED 404, while the transition from NOTALLOWED 404 to ALLOWED 402 may ignore the new value (i.e., the attribute remains NOTALLOWED 404). In one embodiment, if no rule is executed and there is no set value, all attributes with no value may be set to NOTALLOWED 404.

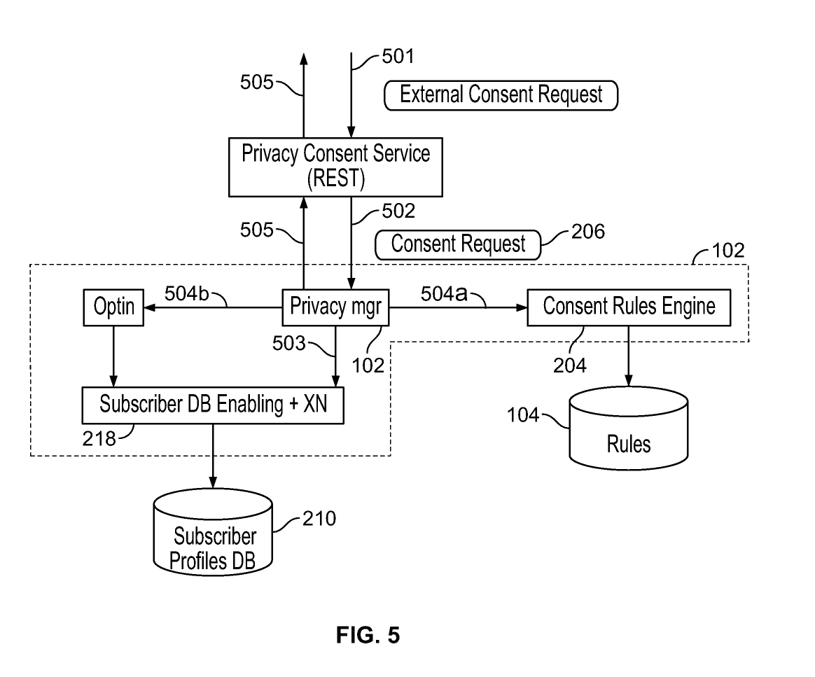

FIG. 5 illustrates a high-level consent request flow according to an embodiment. In one embodiment, an external consent request is received by an external privacy consent service at 501. At 502, a consent request 206 is generated and received by the privacy manager 102. At 503, a subscriber profile including rules associated with the particular subscriber is fetched from the database 104 via the subscriber database enabling function 218. If a subscriber profile exists, the rules may be processed by the rules engine 204 at 504a. Alternatively, an opt-in request may be sent to a subscriber privacy management flow manager 226 if the rules require subscriber opt-in at 504b. At 505, the privacy manager 102 transmits a response parameter back to the requesting entity indicating whether opt-in consent has been granted.

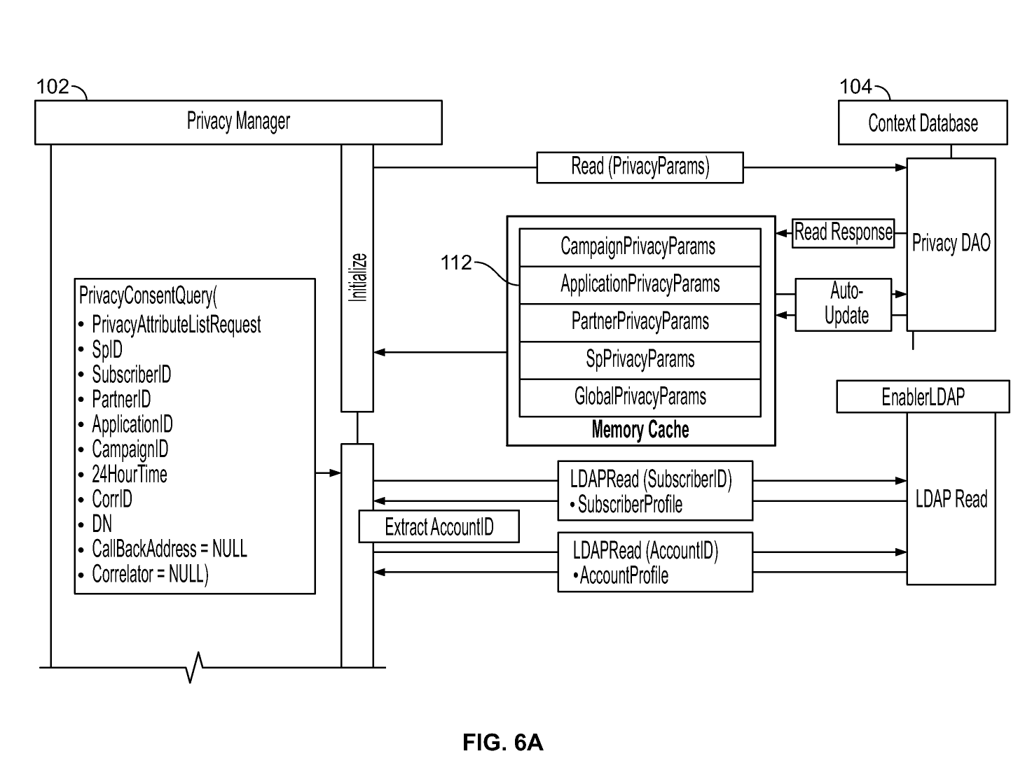

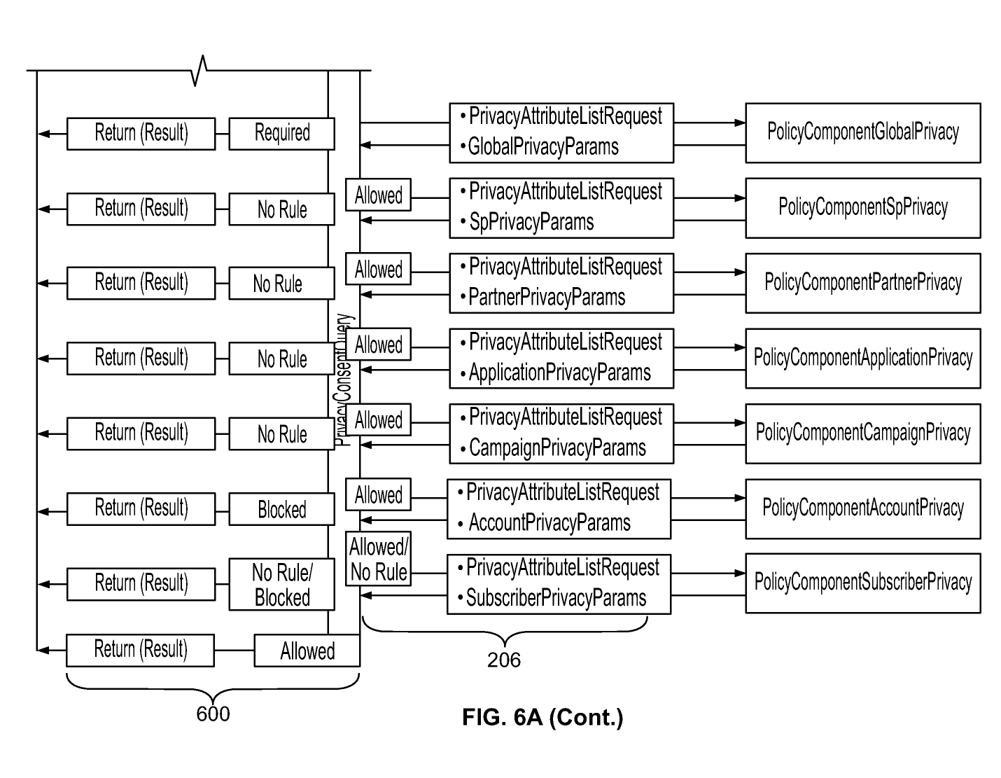

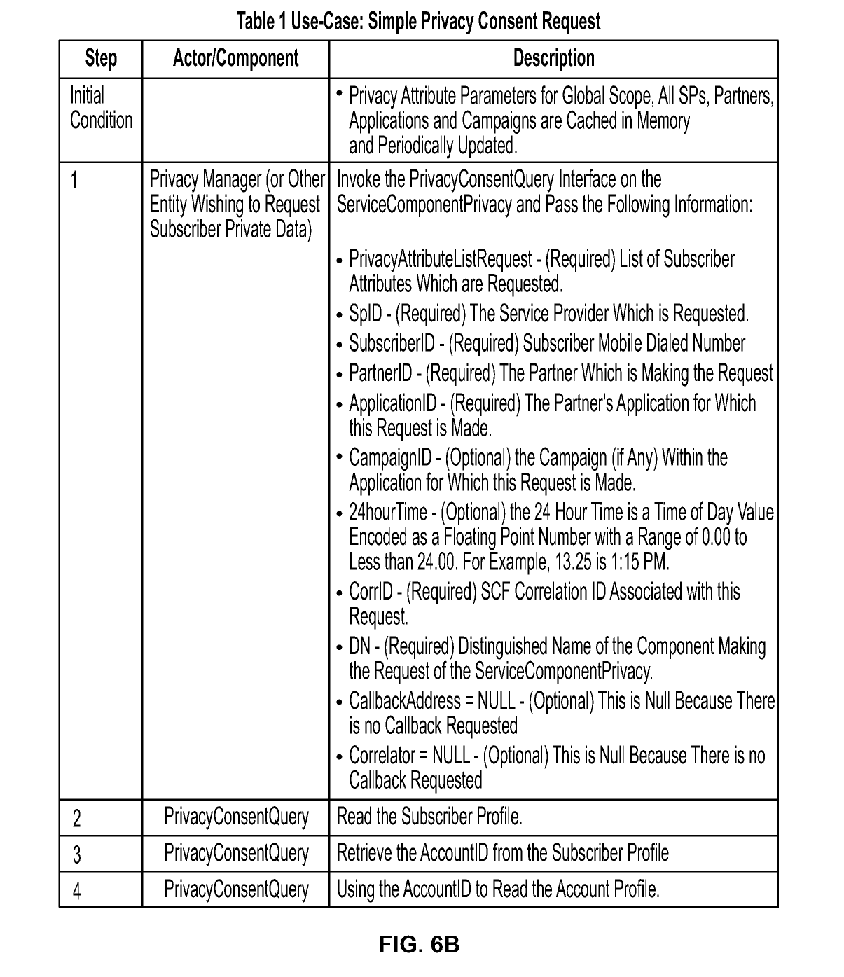

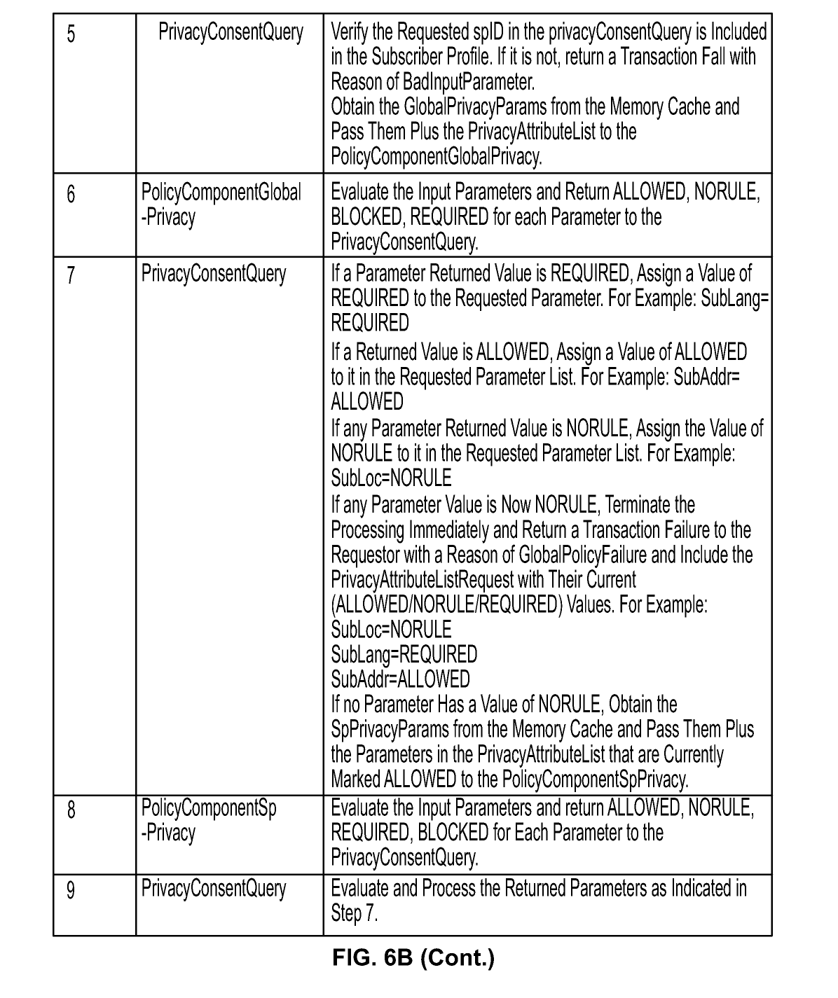

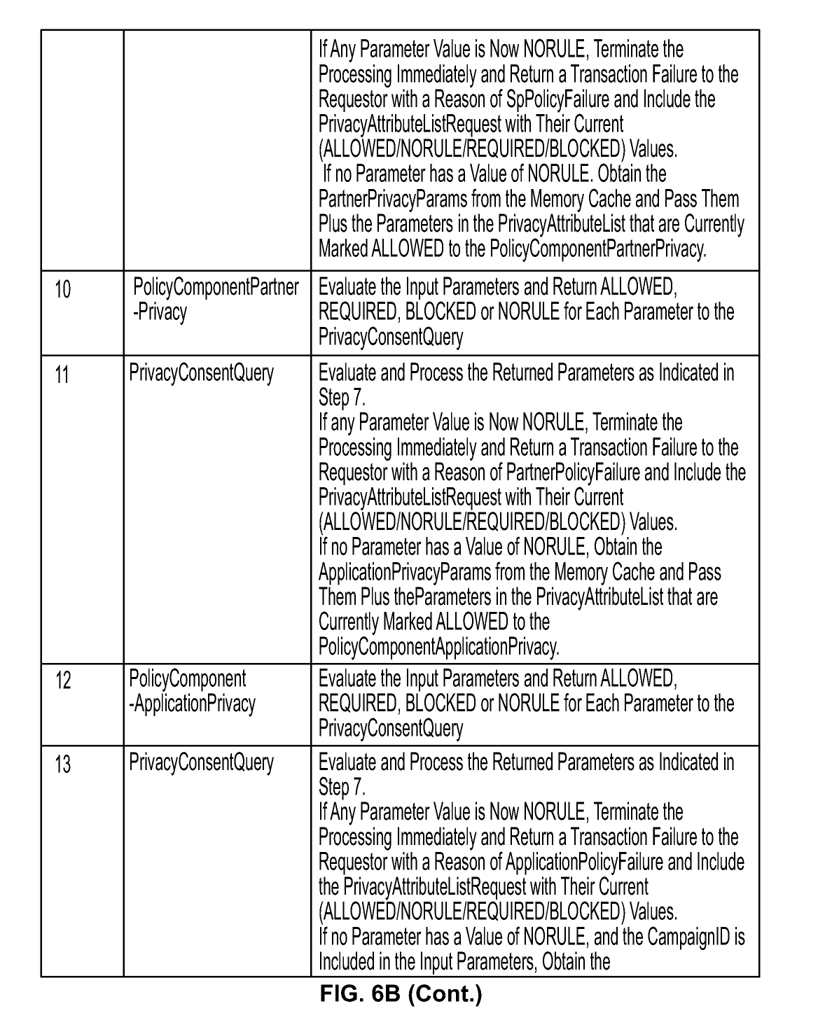

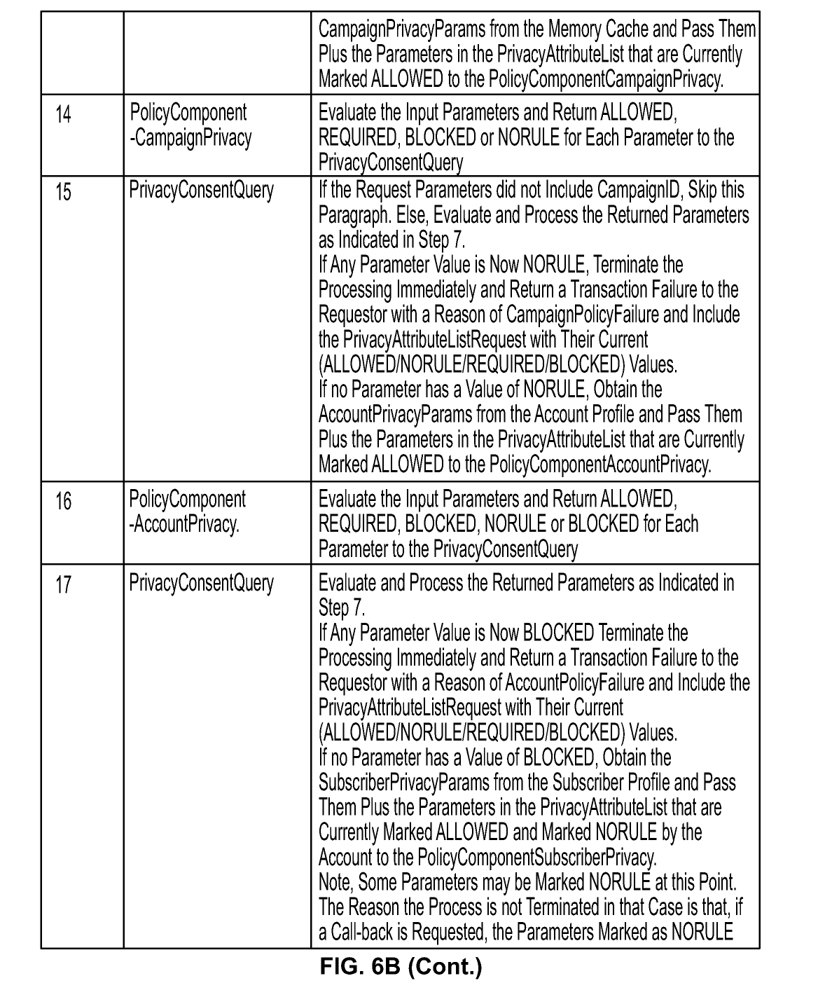

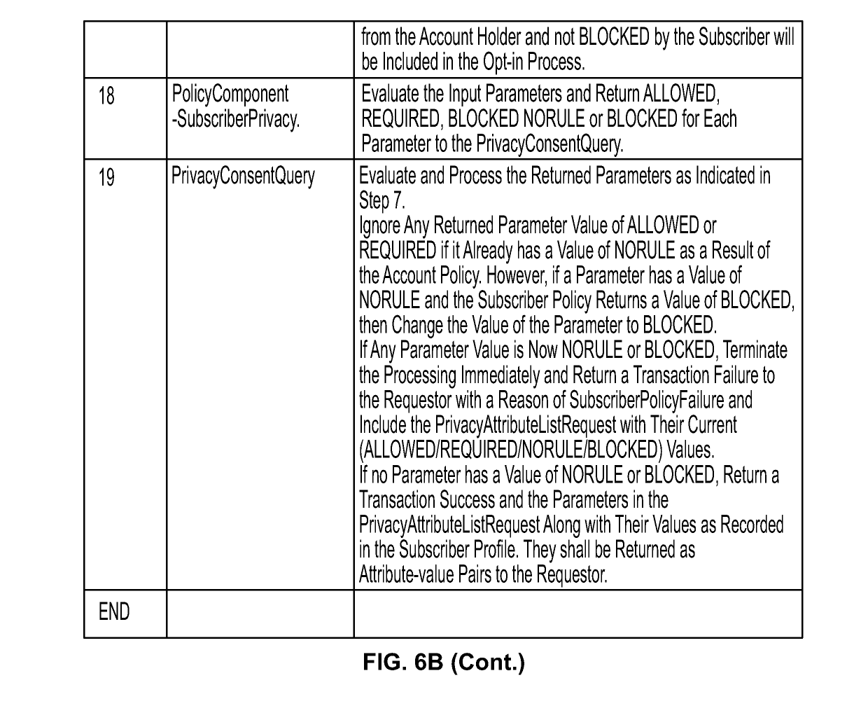

FIG. 6A illustrates a privacy consent request implemented by the privacy manager according to an embodiment. The parameters (e.g., global, service provider, partner, campaign, account and subscriber-level parameters) included in the consent request 206 are evaluated against each policy. As the parameters are evaluated based on each policy stored in the context database 104, the privacy manager 102 takes account of their status 600, e.g., ALLOWED, NOTALLOWED, BLOCKED or REQUIRED. FIG. 6B is a table illustrating the status of each parameter of the consent request in FIG. 6A. For example, if all policies (steps 2-18) pass, the attribute list, including the requested values from the subscriber data, is transmitted to the requestor, such as at step 19.

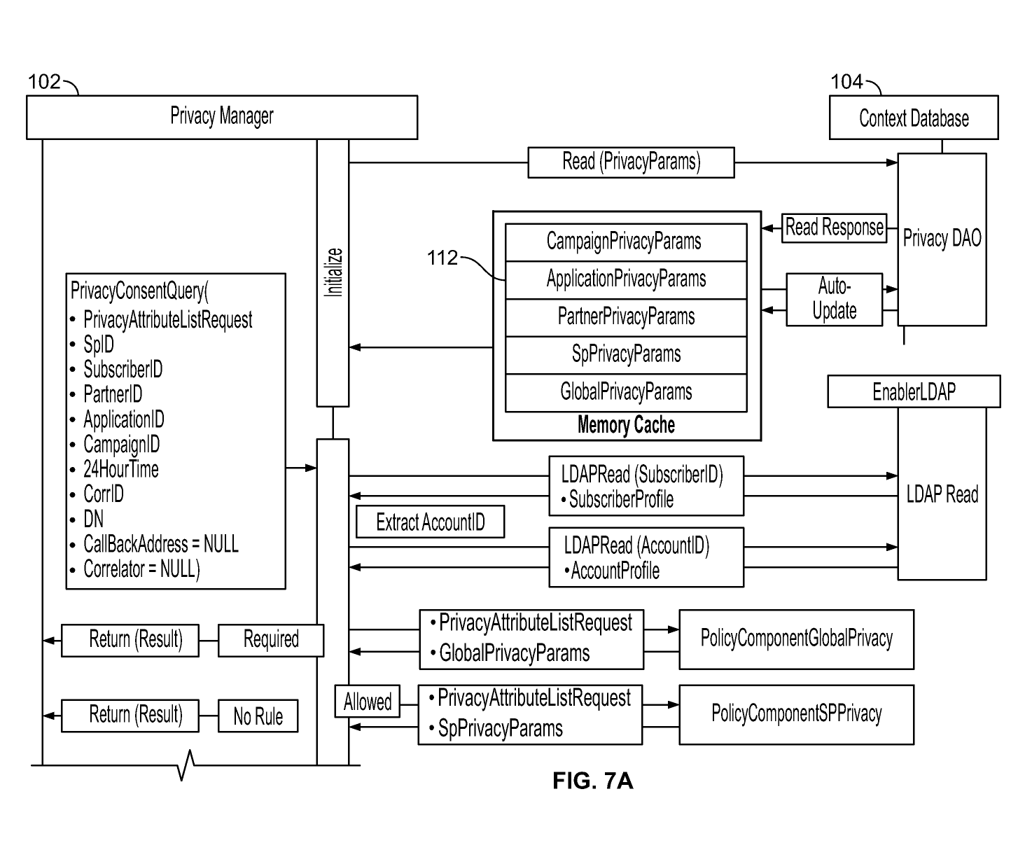

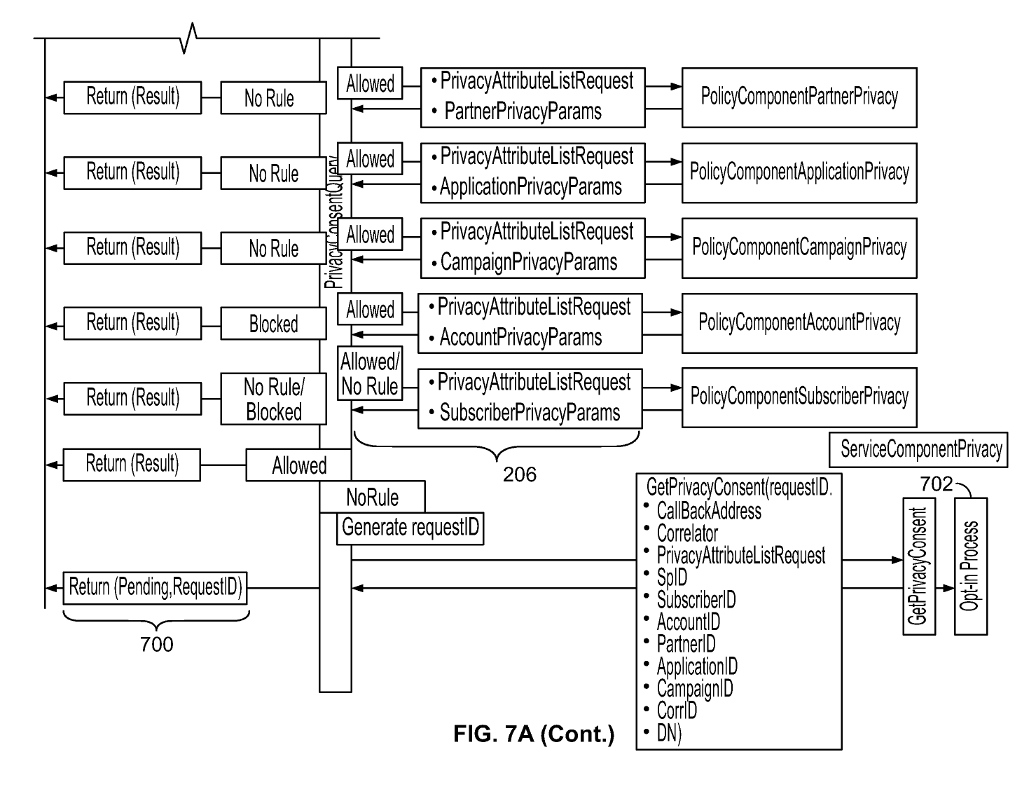

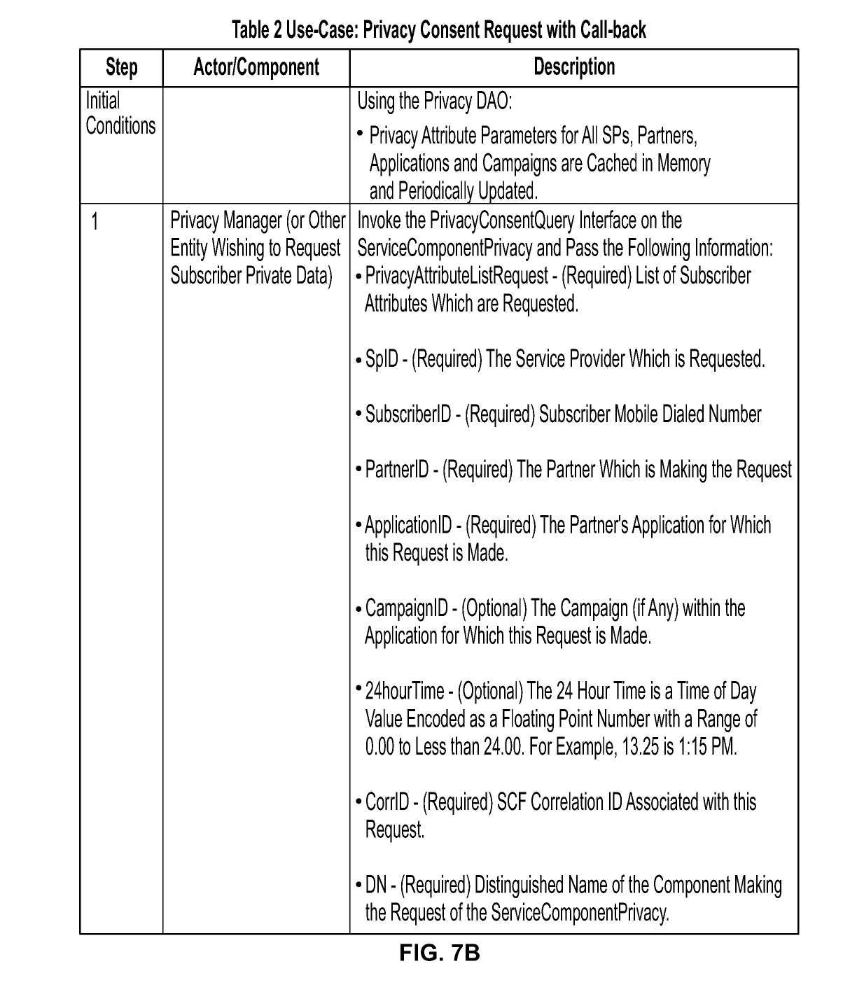

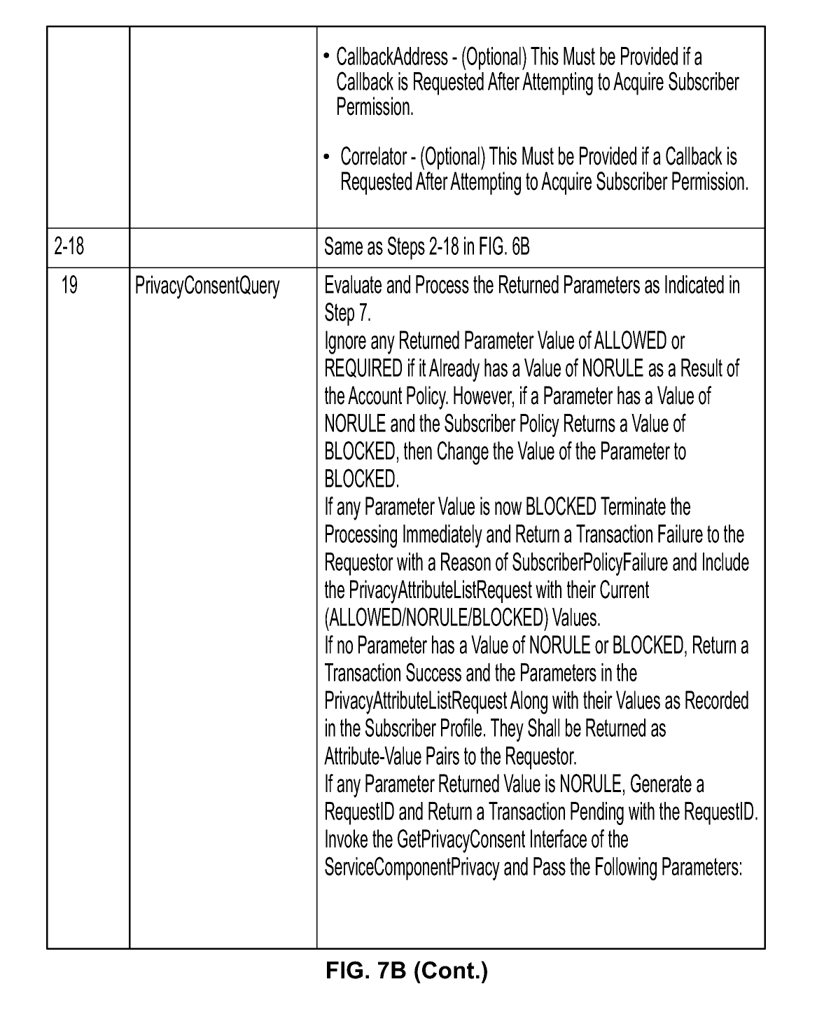

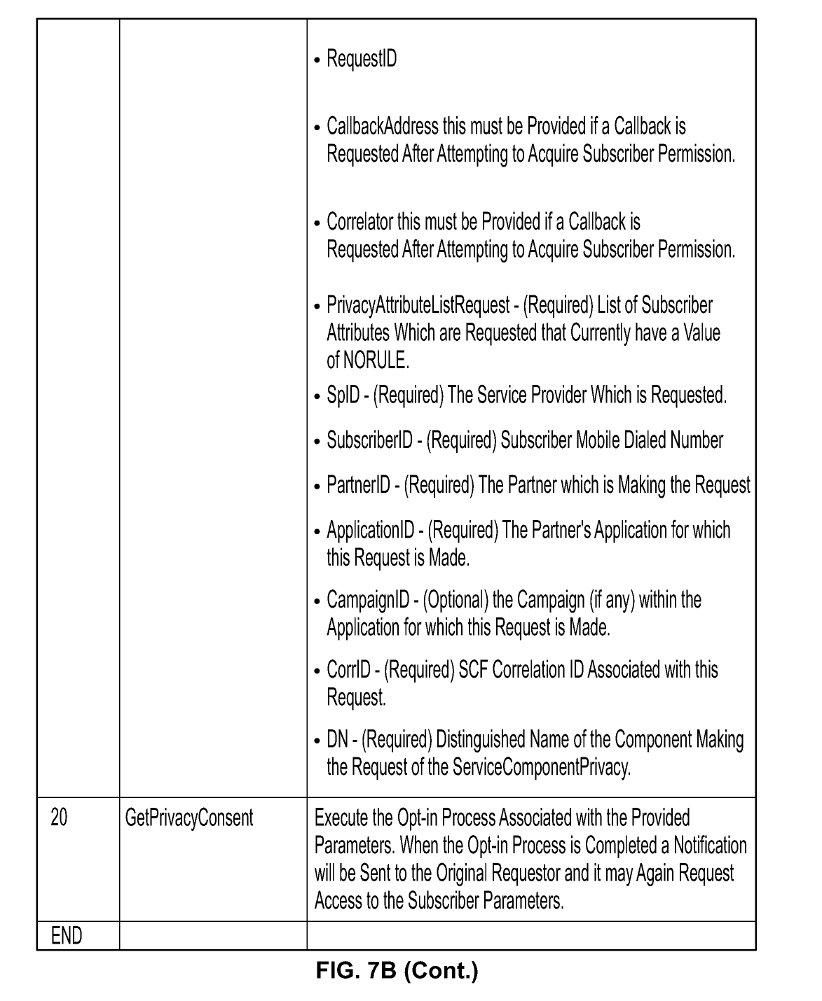

FIG. 7A illustrates a privacy consent request with call back implemented by the privacy manager according to an embodiment. The parameters included in a consent request 206 are evaluated against each policy. As the parameters are evaluated based on each policy, the privacy manager 102 takes account of their ALLOWED, NOTALLOWED, BLOCKED, REQUIRED status 700. In one embodiment, the consent request 206 may include one or more parameters that require a subscriber opt-in process 702. FIG. 7B is a table illustrating the status of each parameter of the consent request in FIG. 7A. If at the end of the process (steps 2-18) any parameter has a value of NORULE at step 19, those parameters are passed to a “getPrivacyConsent” function where the opt-in process 702 will begin. When the opt-in process 702 is completed, a notification parameter will be sent to the requesting entity including the final result of the process. If opt-in is successful (e.g., the privacy manager 102 receives subscriber opt-in permission via the subscriber portal 108), the requesting entity may resubmit the consent request for access to the subscriber parameters to retrieve their value as in step 20.

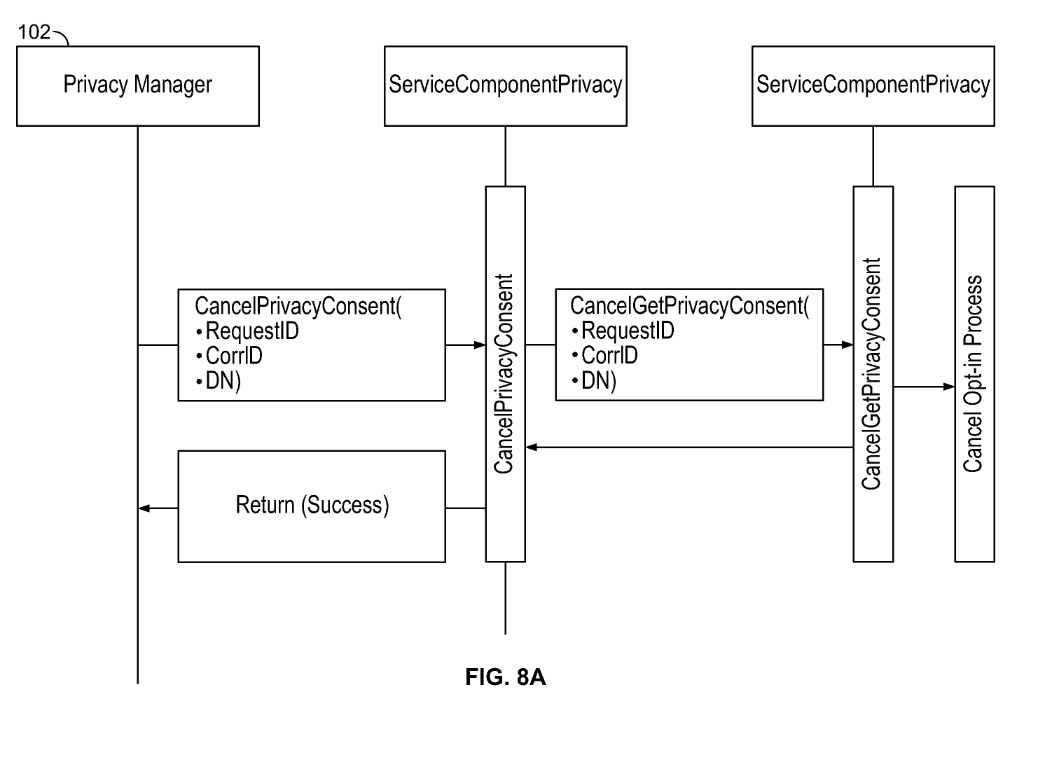

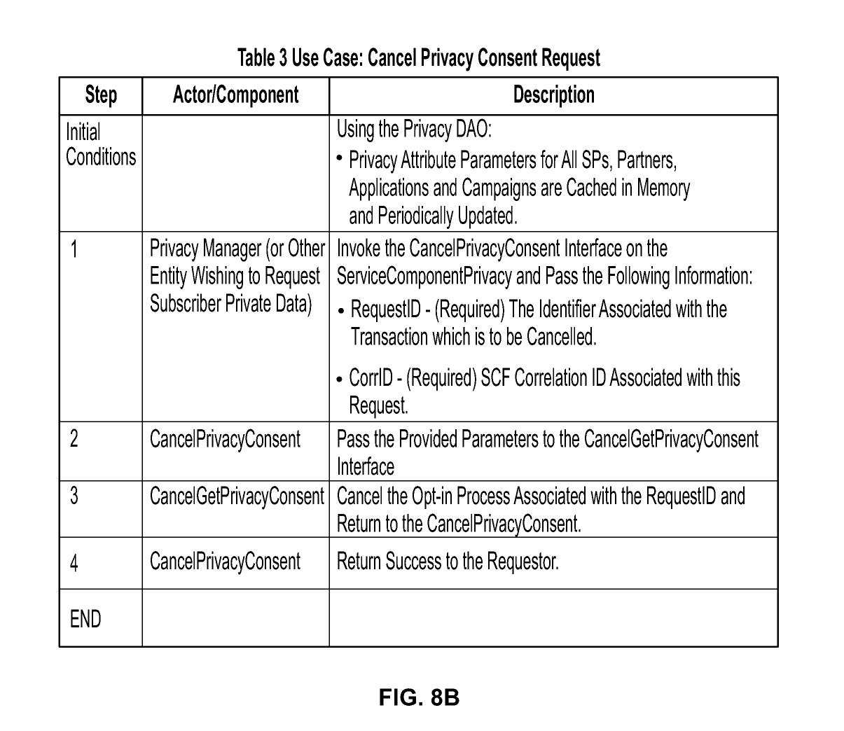

FIG. 8A illustrates a cancel privacy consent request implemented by the privacy manager according to an embodiment. FIG. 8B is a table illustrating the status of each parameter of the cancel consent request in FIG. 8A. Messaging failures are not included in the table, as a failure (e.g., the subscriber does not return an opt-in indication) would simply terminate the consent flow with an error response.

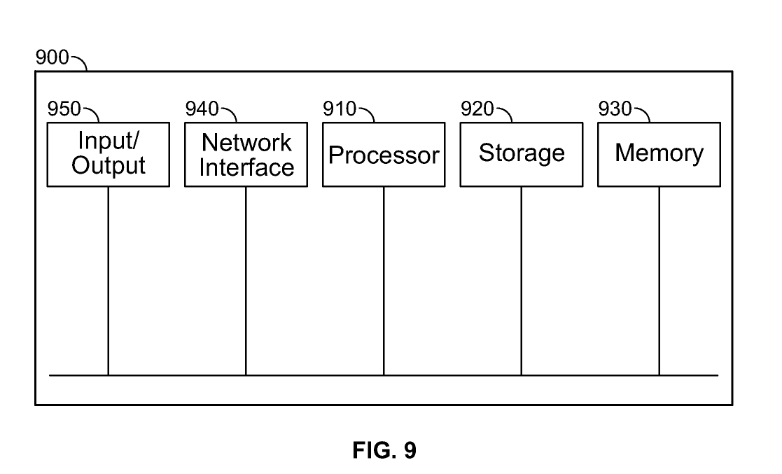

The above-described methods may be implemented on a computer using well-known computer processors, memory units, storage devices, computer software, and other components. A high-level block diagram of such a computer is illustrated in FIG. 9. Computer 900 contains a processor 910, which controls the overall operation of the computer 900 by executing computer program instructions which define such operation. The computer program instructions may be stored in a storage device 920 (e.g., magnetic disk) and loaded into memory 930 when execution of the computer program instructions is desired. When processor-executable computer program instructions are implemented by the processor 910, one or more program code segments of the computer program instructions may combine with the processor 910 to provide a unique device that operates analogously to specific logic circuits. Thus, the steps of the method of FIG. 5 may be defined by the computer program instructions stored in the memory 930 and/or storage 920 and controlled by the processor 910 executing the computer program instructions. The computer 900 may include one or more network interfaces 940 for communicating with other devices via a network for implementing the steps of the method of FIG. 5. The computer 900 may also include other input/output devices 950 that enable user interaction with the computer 900 (e.g., display, keyboard, mouse, speakers, buttons, etc.). One skilled in the art will recognize that an implementation of an actual computer could contain other components as well, and that FIG. 9 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

We claim:

1. A method comprising:
at a processor communicatively coupled to a digital data storage, maintaining a database of subscriber data and subscriber consent rules associated with the subscriber data;
receiving, via an application programming interface communicatively coupled to the processor, a consent request for selected subscriber data;
determining, by the processor in cooperation with the digital data storage, a consent rule associated with the selected subscriber data, wherein the consent rule is determined based on user-type criteria; and
transmitting by the processor in cooperation with the digital data storage, a parameter associated with the selected subscriber data if the consent rule is satisfied.

2. The method of claim 1, further comprising:
determining a plurality of consent rules associated with the selected subscriber data; and
transmitting a parameter associated with the selected subscriber data if each of the plurality of consent rules is satisfied.

3. The method of claim 1, wherein the consent request is received from one of an enterprise application, Web-based application or mobile application.

4. The method of claim 1, wherein the user-type criteria is based on an identity or location of a requesting entity or a target entity.

5. The method of claim 1, further comprising determining a hierarchy level associated with the consent request based on an identity of a requesting entity or a target entity.

6. The method of claim 5, further comprising allowing subscriber management access for a consent rule based on the hierarchy level.

7. The method of claim 5, further comprising determining an access level for the selected subscriber data based on the hierarchy level.

8. The method of claim 1, wherein the consent rule is based on at least one of application, group, temporal or frequency-based criteria.

9. The method of claim 1, wherein the consent rule is enforceable for a particular operation of a consent request.

10. The method of claim 1, wherein the consent rule is satisfied by a subscriber opt-in response.

11. A privacy management apparatus comprising:
an application programming interface configured to receive a consent request for selected subscriber data; and
a processor configured to:
maintain a database of subscriber data and subscriber consent rules associated with the subscriber data;
determine a consent rule associated with the selected subscriber data, wherein the consent rule is determined based on user-type criteria; and
transmit a parameter associated with the selected subscriber data if the consent rule is satisfied.

12. The apparatus of claim 11, wherein the processor is further configured to:
determine a plurality of consent rules associated with the selected subscriber data; and
transmit a parameter associated with the selected subscriber data if each of the plurality of consent rules is satisfied.

13. The apparatus of claim 11, wherein the consent request is received from one of an enterprise application, Web-based application or mobile application.

14. The apparatus of claim 11, wherein the user-type criteria is based on an identity or location of a requesting entity or a target entity.

15. The apparatus of claim 11, wherein the processor is further configured to determine a hierarchy level associated with the consent request based on an identity of a requesting entity or a target entity.

16. The apparatus of claim 15, wherein the processor is further configured to allow subscriber management access for a consent rule based on the hierarchy level.

17. The apparatus of claim 15, wherein the processor is further configured to determine an access level for the selected subscriber data based on the hierarchy level.

18. The apparatus of claim 11, wherein the consent rule is based on at least one of application, group, temporal or frequency-based criteria.

19. The apparatus of claim 11, wherein the consent rule is enforceable for a particular operation of a consent request.

20. The apparatus of claim 11, wherein the consent rule is satisfied by a subscriber opt-in response.

21. An article of manufacture including a non-transitory computer-readable medium having instructions stored thereon, that in response to execution by a computing device causes the computing device to perform operations comprising:
at a processor communicatively coupled to a digital data storage, maintaining a database of subscriber data and subscriber consent rules associated with the subscriber data;
receiving, via an application programming interface communicatively coupled to the processor, a consent request for selected subscriber data;
determining, by the processor in cooperation with the digital data storage, a consent rule associated with the selected subscriber data, wherein the consent rule is determined based on user-type criteria; and
transmitting by the processor in cooperation with the digital data storage, a parameter associated with the selected subscriber data if the consent rule is satisfied.
